(19) United States
(12) Patent Application Publication
(10) Pub. No.: US 2025/0151656 A1
(43) Pub. Date: May 15, 2025

(54) WINDGUARD ASSEMBLY FOR AGRICULTURAL BALER

(71) Applicant: CNH Industrial America LLC, New Holland, PA (US)

(72) Inventor: Todd Hertzler, New Holland, PA (US)

(73) Assignee: CNH Industrial America LLC, New Holland, PA (US)

(21) Appl. No.: 18/506,727

(22) Filed: Nov. 10, 2023

(51) Int. Cl. A01D 89/00; A01F 15/07

(52) U.S. Cl. CPC A01D 89/008; A01D 89/002; A01F 15/07

(57) ABSTRACT

A windguard assembly for a baler that is configured to either limit or prevent crop material from being blown away by the wind during feeding of the crop material into a bale chamber of the baler. The windguard assembly includes a transversely mounted roller that is configured to rotate about an axis of rotation. The roller includes a plurality of crop engaging surfaces that are configured to transport the crop material toward the bale chamber. The windguard assembly also includes a tine assembly that is mounted with respect to the roller. The tine assembly includes a plurality of axially spaced-apart and longitudinally extending tines extending from a transversely mounted shaft. One of the tines of the plurality of tines is independently moveable with respect to another tine of the plurality of tines.

### FIELD OF THE INVENTION

The present invention relates to agricultural balers, and, more particularly, to windguard systems used with such balers.

### BACKGROUND OF THE INVENTION

Agricultural packaging machines, such as balers, for example, are used to consolidate and package crop material so as to facilitate the storage and handling of the crop material for later use. In the case of hay, a mower-conditioner cuts and conditions the crop material for windrow drying in the sun. In the case of straw, an agricultural combine discharges non-grain crop material from the rear of the combine which is to be picked up by the baler. The crop material is typically raked and dried, and a baler, such as a round baler or a square baler, for example, straddles the windrows and travels along the windrows to pick up the crop material and form it into round or square bales. More specifically, a pickup unit at the front of the baler gathers the cut and windrowed crop material from the ground and then conveys the cut crop material into a bale-forming chamber within the baler. After the bale is formed and wrapped by a wrapping mechanism, the rear portion of the baler is configured to open and discharge the bale onto the field.

The pickup unit of some balers includes a pickup reel and a windguard with tines. The tines hold down the hay or other crop material as it is being fed by the pickup reel to prevent the crop material from being blown off the reel and to ensure an adequate compaction of the crop material. Many known windguard designs suffer from dead spaces where the crop is not held closely by the windguard against the pickup tines of the reel throughout the entire crop path. The dead spaces may be either radially along the tine path or axially along the width of the pickup reel as one side of the reel feeds more crop than the other side of the reel. Described herein is an improved windguard design that seeks to eliminate the dead spaces.

### SUMMARY OF THE INVENTION

According to one aspect, a windguard assembly for a baler is configured to either limit or prevent crop material from being blown away by the wind during feeding of the crop material into a bale chamber of the baler. The windguard assembly includes a transversely mounted roller that is configured to rotate about an axis of rotation. The roller includes a plurality of crop engaging surfaces that are configured to transport the crop material toward the bale chamber. The windguard assembly also includes a tine assembly that is mounted with respect to the roller. The tine assembly includes a plurality of axially spaced-apart and longitudinally extending tines extending from a transversely mounted shaft. One of the tines of the plurality of tines is independently moveable with respect to another tine of the plurality of tines.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an embodiment of an agricultural baler that includes a windguard assembly shown in phantom lines;

FIG. 2 illustrates a perspective view of the windguard assembly of FIG. 1;

FIG. 3 illustrates a side elevation view of the windguard assembly of FIG. 2;

FIG. 4 is a side elevation view of a segment of the baler of FIG. 1 including the windguard assembly;

FIG. 5 is a detailed view showing a biasing element connected to a single independently rotatable tine of the windguard assembly; and

FIG. 6 is a detailed view showing a biasing element connected to a gang of tines of the windguard assembly.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The terms “forward,” “rearward,” “upward,” “downward,” “left,” and “right,” when used in connection with the agricultural baler described herein and/or components thereof are usually determined with reference to the direction of forward operative travel of the towing vehicle and the height of the baler, but they should not be construed as limiting. The terms “longitudinal” and “transverse” are determined with reference to the fore-and-aft direction of the towing vehicle and the width of the baler, and are equally not to be construed as limiting.

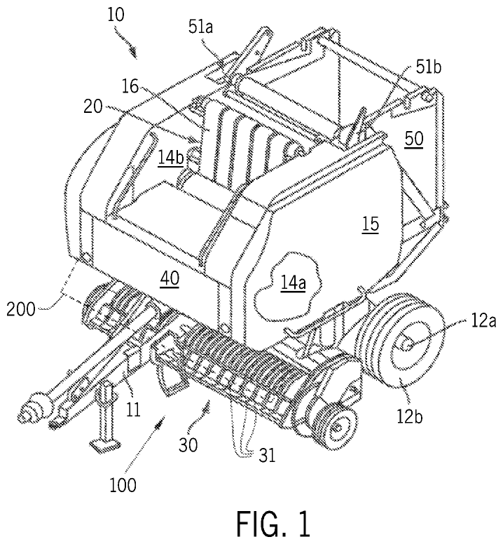

Referring now to the drawings, and more particularly to FIG. 1, illustrated is a round baler 10, which can be connected to and pulled behind an agricultural vehicle, such as a tractor (not shown), for example. The baler 10 includes a chassis terminating forwardly in a tongue 11 and rearward slightly beyond a transverse axle 12a to which a pair of wheels 12b (only one shown) is mounted, thus forming a wheel supported chassis. The chassis supports a series of belts 16 and floor rolls, which together with a first sidewall 14a (shown in the breakout) behind and generally parallel to cover panel 15 and a second sidewall 14b, collectively form a bale chamber 20. Cut crop material is lifted from windrows into the baler 10 using a pickup assembly 100. The pickup assembly 100 generally includes a transversely oriented rotatable pickup roll 30 and a plurality of tines 31 carried by the pickup roll 30.

From the pickup assembly 100, the crop material is transported to and fed through a feeding assembly into the bale chamber 20. As the crop material enters the bale chamber 20, multiple carrier elements, e.g. rollers, chains and slats, and/or belts (e.g., a series of conveyor belts 16), for example, begin to roll a bale of hay within the chamber, forming a cylindrically shaped bale. These carrier elements are movable so that the chamber can initially contract and subsequently expand to maintain an appropriate amount of pressure on the periphery of the bale. The bale is then optionally wrapped with twine or a net wrapping material dispensed from a wrapping mechanism generally arranged behind shield 40. Upon completion of the optional wrapping process, tailgate 50 pivots upwardly about pivot points 51a, 51b and the bale is discharged onto the ground.

Further details of baler 10 may be described in U.S. Pat. No. 11,547,053, which is incorporated by reference herein in its entirety and for all purposes.

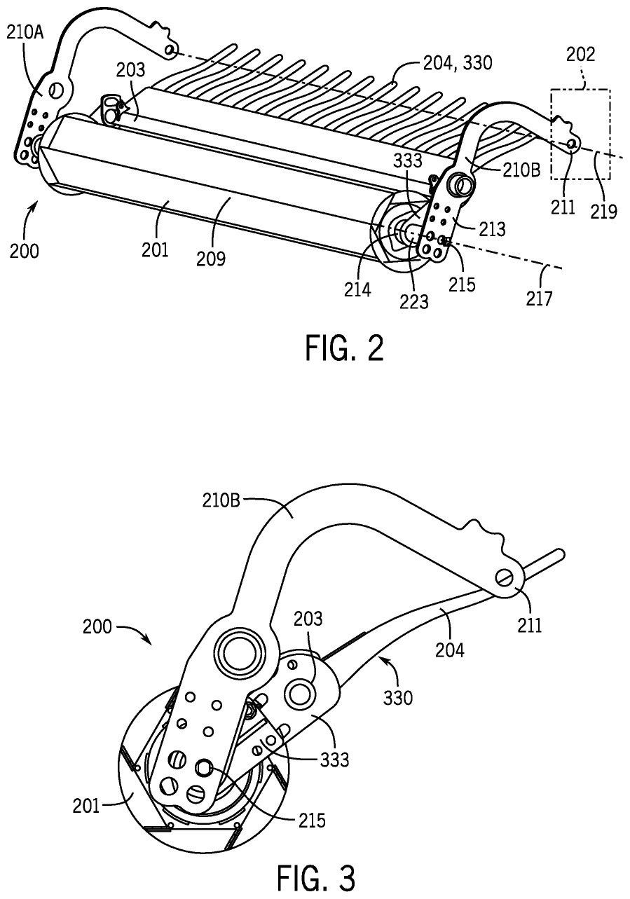

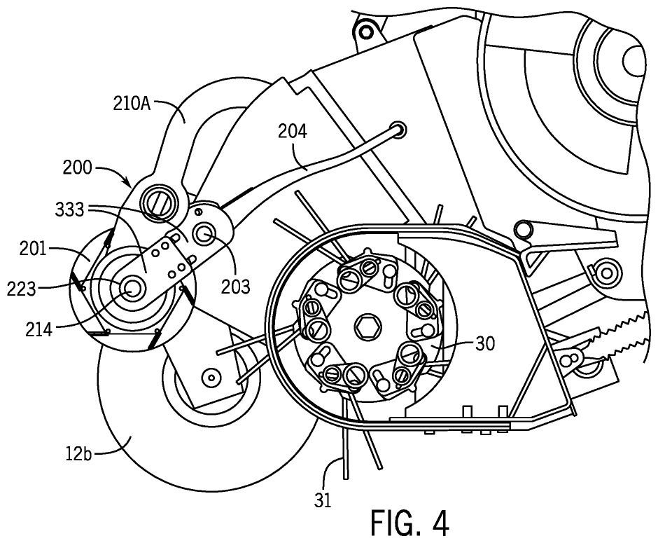

Referring now to FIGS. 2-4, the baler 10 includes a windguard assembly 200 that includes a transversely mounted windguard roll (or roller) 201 that is rotatably coupled to a frame structure 202 of baler 10 (shown schematically) by a pair of arms 210A, 210B. The cylindrical body of roll 201 has a series of transversely mounted bars 209 (i.e., crop engaging surfaces) arranged about its perimeter for compacting the crop material against the pickup roll 30. Roll 201 rotates as the crop moves over its surfaces and is not actively powered by a belt or actuator, however, roll 201 may be actively powered, if so desired.

Each arm 210A, 210B has a curved shape that includes a first end 211 including an opening that is pivotably coupled to the frame 202 by a pin or fastener (for example) and a second end 213, which is opposite the first end 211, to which the windguard roll 201 is mounted. Roll 201 includes a central shaft 214, and ends of shaft 214 are mounted to respective bearings or bushings 223. Each second end 213 includes a plurality of openings (four shown) one of which is mounted to one of the bushing 223 by a pin, bearing or fastener 215. It should be understood that roll 201 rotates about an axis 217 defined through shaft 214. Axis 217 also passes through bushing 223 and fastener 215. Axis 217 may also be described as the longitudinal axis or axis of rotation of roll 201. It should be understood that roll 201 is rotatable about its own axis 217, whereas roll 201 is pivotable with respect to frame 202 about a different axis 219 defined by arms 210A, 210B.

Windguard assembly 200 also includes a tine assembly 330 that is pivotably mounted relative to roll 201. Tine assembly 330 includes a rod, tube or shaft 203, elongated fingers or tines 204 extending rearwardly from shaft 203, and arms 333 fixed to opposing sides of shaft 203. The components of tine assembly 330 may form a weldment that are fixedly mounted together. Shaft 203 and its tines 204 are mounted to bushing 223 (or shaft 214 of roll 201) by arms 333. Arms 333 are pivotably mounted about axis 217 by bushing 223.

Arms 333 may pivot either freely or by a limited amount about axis 217 to adjust to the volume of crop flowing beneath tines 204. Although not shown, a rotation limiter (e.g., a bracket, flange or pin in slot) may be connected between arms 333 and arms 210 (or frame 202) to limit pivoting action of tine assembly 330 relative to frame 202 (and about axis 217) between two end points. It should be understood that roll 201 can rotate about axis 217 while arms 333 remain stationary, and arms 333 can pivot about axis 217 while roll 201 remains stationary.

As compared with some known windguards, the windguard tines 204 of windguard assembly 200 are better configured to hold the crop against the pick-up tines 31, thereby improving feeding performance of pick-up assembly 100 by eliminating any dead spots between tine assembly 330 and pickup assembly 100. Specifically, by arranging the pivot axis of tines 204 on the axis of rotation of roller 201, tines 204 are positioned closer to the flow of crop as well as closer to the pick-up roll 30 of pick-up assembly 100.

Shaft 203 and its tines 204 may be non-rotatable (i.e., fixed) with respect to arms 333, as described above. Alternatively, shaft 203 and its tines 204 may be pivotably mounted to arms 333. Such an additional point of rotation would allow the tines 204 to more closely follow the path of crop flow and be in even closer proximity to the pick up roll 30. Shaft 203 may be either freely pivotable with respect to arms 333 or pivotable to a limited degree relative to shaft 203. For example, a rotation limiter (e.g., a bracket, flange or pin in slot) may be connected between shaft 203 and arms 333 to limit pivoting action of shaft 203 and tines 204 relative to arms 333 between two end points.

It is noted that according to a different embodiment, the arms 333 may be omitted and the shaft 203 could be pivotably connected to the arms 210A and 210B at point 301 (FIG. 3). Such an embodiment would not necessarily have all of the advantages of the prior embodiments because the shaft 203 may be positioned further from the pick-up roll 30.

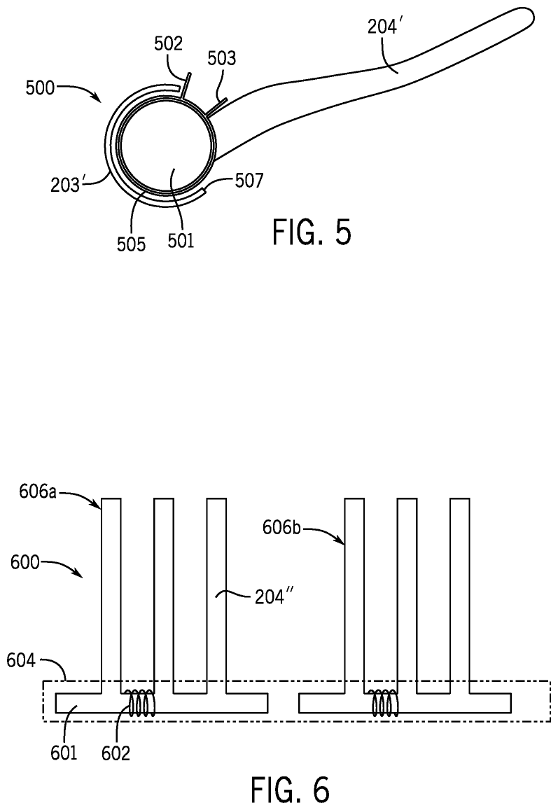

Turning now to FIG. 5, as noted in the background, the dead spaces may be either radially along the tine path or axially along the width of the pickup reel as one side of the reel feeds more crop than the other side of the reel. If the tine assembly is a single monolithic unit like that shown in FIG. 2, every tine of the tine assembly will move to the same rotational position regardless of whether the crop load is non-uniformly distributed across the width of the tine assembly. And, when the crop is non-uniformly distributed across the width of the tine assembly, the tines that are under a heavy crop load will sufficiently compress the crop against the pick-up roll 30, whereas, the tines that are under a light crop load may not sufficiently compress the crop against the pick-up roll 30. In other words, an individual tine of a monolithic tine assembly cannot adjust to the local crop load at that tine.

Based on the challenges noted above, FIG. 5 depicts an alternative tine assembly 500 having independently moveable tines 204′. The tine assembly 500 is substantially the same as tine assembly 200 and only the differences therebetween will be described hereinafter. Instead of all of the tines 204 being integrated and interconnected together to a single shaft 203, the tines 204′ of tine assembly 500 are independently moveable with respect to one another. Each tine 204′ includes an elongated finger extending from a base end 501. The cylindrical base end 501 is pivotably positioned within a hollow region of the shaft 203′. The shaft 203′ is substantially the same as the shaft 203 with the exception that the shaft 203′ is a tube having an exposed cutout or channel 507. A biasing element 505, in the form of a torsion spring includes a coiled portion that terminates at two ends 502 and 503. One end 502 is positioned against a surface of the channel 507 and the other end 503 is positioned against a surface of the tine 204′. Biasing element 505 biases tine 204′ in a downward direction toward pick-up roll 30. Each tine 204′ includes its own biasing element 505. By making the tines 204′ of tine assembly 500 independently moveable with respect to one another, each tine 204′ can adjust to the crop load at that tine 204′. The biasing element 505 is not limited to a torsion spring, and may be a compression spring, a tension spring, an elastic element, or a deformable element, for example.

As an alternative to the embodiment shown in FIG. 5, the base 501 of the tine 204′ could include a hole through which the solid shaft 203′ passes, and the biasing element 505 could surround the shaft 203′, and the ends of biasing element 505 could bear on a surface of shaft 203′ and a surface of the tine 204′ to bias the tine 204′ toward the pick-up roll 30.

FIG. 6 depicts another alternative tine assembly 600. The tine assembly 600 is substantially the same as tine assembly 500 and only the differences therebetween will be described hereinafter. Instead of having every tine being independently moveable with respect to each another, the tines 204″ of tine assembly 500 are grouped into a plurality of tine gangs 606a and 606b (only two tine gangs are shown). Each tine gang 606a includes a plurality of tines 204″ extending from a base end 601 that are fixed together (i.e., forming a single unit) and a single biasing element 602 that is positioned to bias tines 204″ of that gang with respect to shaft 604 and in a downward direction toward pick-up roll 30. The base end 601 of each tine gang is positioned within the shaft 604. Alternatively, the base ends 601 could include holes through which the shaft 604 passes, as was described in the paragraph above.

Each tine gang 606a/b includes a plurality of tines 204″ and those tines constitute a subset of the total number of tines 204″ that form part of the entire tine assembly 600. By making the tine gangs 606a/b of tine assembly 600 independently moveable with respect to one another, each tine gang 606a/b can adjust to the crop load at that tine gang. The embodiment shown in FIG. 6 would be easier to assemble than the embodiment of FIG. 5 because the embodiment of FIG. 6 includes less biasing elements.

The windguard assembly illustrated in the figures and described above can be implemented in any hay and forage agricultural vehicle that harvests a grass type crop, including but not limited to pull-type forage harvester grass pickups, self-propelled forage harvester grass pickups, round baler pickups, small square baler pickups, or large square baler pickups, for example.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A windguard assembly for a baler that is configured to either limit or prevent crop material from being blown away by the wind during feeding of the crop material into a bale chamber of the baler, said windguard assembly including:
a transversely mounted roller that is configured to rotate about an axis of rotation, wherein the roller includes a plurality of crop engaging surfaces that are configured to transport the crop material toward the bale chamber; and
a tine assembly that is mounted with respect to the roller, the tine assembly comprising a plurality of axially spaced-apart and longitudinally extending tines extending from a transversely mounted shaft, wherein one of the tines of the plurality of tines is independently moveable with respect to another tine of the plurality of tines.

2. The windguard assembly of claim 1 further comprising a biasing element for biasing said one of the tines toward a pick-up roller of the baler.

3. The windguard assembly of claim 2, wherein the biasing element is a torsion spring.

4. The windguard assembly of claim 2, wherein one portion of the biasing element bears on the shaft and another portion of the biasing element bears on a surface of the tine assembly to bias said one of the tines toward the pick-up roller.

5. The windguard assembly of claim 1, wherein the tine assembly further comprises arms that are mounted to a bushing that is connected to a shaft of the roller, and wherein the arms are further configured to be connected to a frame of the baler.

6. The windguard assembly of claim 5, wherein the shaft of the tine assembly is mounted to the arms.

7. The windguard assembly of claim 5, wherein the shaft of the tine assembly is pivotably mounted to the arms to a define a second point of rotation for the tines.

8. The windguard assembly of claim 4, wherein each arm has a first end that is pivotably mounted to the frame of the baler and a second end, opposite the first end, that is mounted to the roller, and wherein the windguard assembly is pivotable with respect to the frame about an axis that passes through the first ends of the arms.

9. The windguard assembly of claim 8, wherein the second end is also mounted to the bushing such that the roller can rotate with respect to the arms.

10. The windguard assembly of claim 1, wherein the tine assembly comprises a plurality of tine gangs, wherein each tine gang includes a plurality of the tines and a biasing element for independently biasing said tine gang toward a pick-up roller of the baler.

11. The windguard assembly of claim 10, wherein the biasing element is configured for biasing one tine gang of the plurality of tine gangs relative to another tine gang of the plurality of tine gangs such that said one tine gang can move independently.

12. The windguard assembly of claim 10, wherein each tine gang includes the plurality of the tines that are connected together by a base, and wherein the base is at least partially mounted to the shaft for rotating relative to the shaft.

13. The windguard assembly of claim 1, wherein the tine assembly is pivotably mounted with respect to the roller about the axis of rotation.

14. An agricultural baler comprising the windguard assembly of claim 1, wherein the transversely mounted roller is configured to compress crop against a rotatable pick-up roller of the baler.

15. An agricultural vehicle comprising the agricultural baler of claim 1, wherein the agricultural baler comprises a tongue that is mounted to a hitch on the agricultural vehicle.
